(19) United States
(12) Patent Application Publication
(10) Pub. No.: US 2015/0378985 A1
(43) Pub. Date: Dec. 31, 2015

(54) METHOD AND SYSTEM FOR PROVIDING SEMANTICS BASED TECHNICAL SUPPORT

(71) Applicants: Dhanyamraju S U M Prasad, Hyderabad (IN); Satya Sai Prakash K, Hyderabad (IN); Simy Chacko, Hyderabad (IN); Sekhar Ramaraju, Hyderabad (IN); Shiva Sholayyappan, Hyderabad (IN)

(72) Inventors: Dhanyamraju S U M Prasad, Hyderabad (IN); Satya Sai Prakash K, Hyderabad (IN); Simy Chacko, Hyderabad (IN); Sekhar Ramaraju, Hyderabad (IN); Shiva Sholayyappan, Hyderabad (IN)

(21) Appl. No.: 14/507,838

(22) Filed: Oct. 7, 2014

(30) Foreign Application Priority Data
Jun. 26, 2014 (IN) 3115/CHE/2014

(51) Int. Cl. G06F 17/27

(52) U.S. Cl. CPC G06F 17/2785

(57) ABSTRACT

A method and system for providing semantics based technical support. The embodiments herein relates to providing semantics based technical support, and more particularly to providing semantics based technical support based on available knowledge sources and similarity of technical support issues. Embodiments disclosed herein provide users with requisite information in real time while an issue is being reported.

### TECHNICAL SUPPORT

The present application is based on, and claims priority from, Indian Complete Application number 3115/CHE/2014 filed on 26 Jun. 2014, the disclosure of which is hereby incorporated by reference herein

### TECHNICAL FIELD

The embodiments herein relates to providing semantics based technical support, and more particularly to providing semantics based technical support based on available knowledge sources, prior code fixes and similarity of technical support issues.

### BACKGROUND

Customer service is a very important part of the service industry, wherein the service may be a retail environment, an ecommerce environment, a software development environment and so on. However, the challenges faced by each industry are different. There have been solutions in the retail environment and the ecommerce environment to provide satisfactory levels of customer service. Fundamentally these customer queries are transient in nature.

In a software development environment, the challenges are different to the typical service industry in terms of the customers, the service expected by the customers, their typical queries and so on. The typical queries may be related to the installation process, functional requirements and so on. In this scenario, queries tend to be persistent and probing. Providing adequate support requires considerable knowledge and depth of the problem, the software and the solution to the query, especially if the organization providing the support is keen on CSAT (Customer Satisfaction). To improve CSAT, the organization must constantly reduce the turn-around time (TAT).

### SUMMARY

Accordingly the embodiments herein provides a method for providing semantics based technical support to a user, the method comprising of indexing contents of a bug repository by a semantic recommendation engine; indexing contents at least one knowledge source by the semantic recommendation engine; mapping the indexed contents of the bug repository to the indexed contents of the at least one knowledge source by the semantic recommendation engine; mapping historical bugs to solutions for the historical bugs by the semantic recommendation engine; and providing a recommendation to the user by the semantic recommendation engine based on the mapping, on the semantic recommendation engine detecting the user reporting a query.

Also, provided herein is a computer program product comprising computer executable program code recorded on a computer readable non-transitory storage medium, said computer executable program code when executed, causing a method for providing semantics based technical support to a user, comprising indexing contents of a bug repository; indexing contents at least one knowledge source; mapping the indexed contents of the bug repository to the indexed contents of the at least one knowledge source; mapping historical bugs to solutions for the historical bugs; and providing a recommendation to the user based on the mapping, on the semantic recommendation engine detecting the user reporting a query.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

The embodiments are illustrated in the accompanying drawings, through out which like reference letters indicate corresponding parts in the various figures. The embodiments herein will be better understood from the following description with reference to the drawings, in which:

FIG. 1 depicts a system for providing semantics based technical support, according to embodiments as disclosed herein;

FIG. 2 depicts the semantic recommendation engine, according to embodiments as disclosed herein;

FIG. 3 is a flowchart illustrating the process of performing semantics based analysis on repositories, according to embodiments as disclosed herein;

FIG. 4 is a flowchart illustrating the process of providing technical support to a client based on semantics based analysis, according to embodiments as disclosed herein; and

FIG. 5 illustrates a computing environment implementing the method for providing semantics based technical support based on available knowledge sources and similarity of technical support issues, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

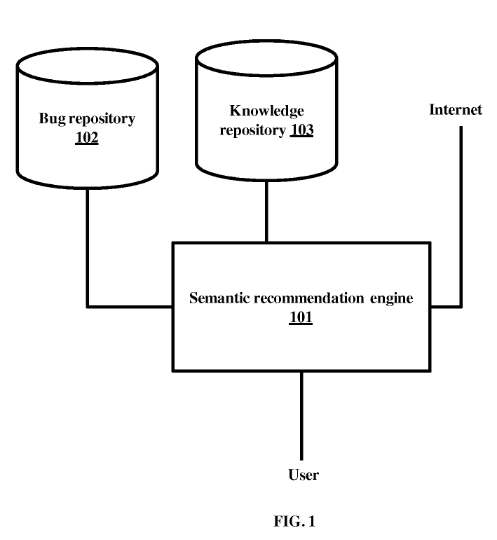

The embodiments herein disclose a method and system for providing semantics based technical support based on available knowledge sources and similarity of technical support issues. Referring now to the drawings, and more particularly to FIGS. 1 through 5, where similar reference characters denote corresponding features consistently throughout the figures, there are shown preferred embodiments.

FIG. 1 depicts a system for providing semantics based technical support, according to embodiments as disclosed herein. The system, as depicted comprises of a semantic recommendation engine 101 connected to at least one bug repository 102 and at least one knowledge repository 103. The bug repository 102 may comprise of bugs/issues reported to an organization to which the repository 102 belongs, solutions to bugs/issues reported to the organization, bugs/issues reported to an organization who provides support to the same software/similar software and so on, solutions to bugs/issues reported to an organization who provides support to the same software/similar software and so on, bugs/issues reported in publicly available repositories (such as the internet), solutions to bugs/issues reported in publicly available repositories and so on. The knowledge repository 103 comprises of documents (white papers, technical documents and so on) available in the organization, software code repositories and so on. The semantic recommendation engine 101 may be connected to the repositories 102, 103 using a network such as a Local Area Network (LAN), Wide Area Network (WAN), the internet and so on. The semantic recommendation engine 101 may be connected to the internet also. The internet may provide further access to other knowledge repositories (such as online forums, social network pages, technical support pages/platforms and so on) and other sources of information such as dictionaries, thesauruses and so on.

The semantic recommendation engine 101 may be connected to at least one user. The user may be a person providing software support to a user of the software, the user of the software or any other person authorized to access the semantic recommendation engine 101.

The semantic recommendation engine 101 may index information present in the repositories 102, 103 using a suitable means to create a bug index and a knowledge index respectively. The semantic recommendation engine 101 may perform mapping between the bug index and the knowledge index. The semantic recommendation engine 101 may perform mapping between historical issues (which may be present in the bug repository 102, the knowledge repository 103 or any other suitable means) to solutions to the issues. The semantic recommendation engine 101 offers recommendations to the user based on the mapping, while the user is reporting a query (wherein the reporting may comprise of the user typing the query, orally reporting the query and so on).

The terms ‘bug’, ‘issue’ and ‘query’ have been used interchangeably herein and all the fore mentioned terms may indicate a query received which is related to the software product.

The software product as disclosed herein may be a software product designed to run on a computing device (such as a computer, laptop, tablet, mobile phone and so on), embedded software or any other product which comprises of at least one software code.

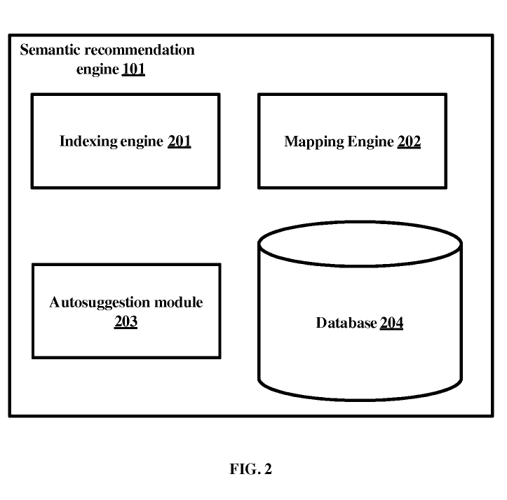

FIG. 2 depicts the semantic recommendation engine, according to embodiments as disclosed herein. The semantic recommendation engine 101 comprises of an indexing engine 201, a mapping engine 202, an autosuggestion module 203 and at least one database 204. The database 204 may be used for storing data. The database 204 may be co-located with the semantic recommendation engine 101. The database 204 may be located remotely from the semantic recommendation engine 101 and connected to the semantic recommendation engine 101 using a suitable connection means.

The indexing engine 201 may index the bug repository 102. The indexing engine 201 may use a suitable method for indexing such as LSA (Latent Semantic Analysis) and so on. The indexing engine 201 may perform the indexing based on frequency of occurrence of phrases (wherein the phrase may be a single word/term, a sequence of words/terms and so on) within the bug repository 102. The indexing engine 201 may also consider the proximity between various terms for purposes of indexing. The indexing engine 201 may consider synonyms and acronyms during the process of indexing. The indexing engine 201 may distribute the indexed contents of the bug repository 102 based on a plurality of factors such as the frequency of occurrence of phrases and so on. The indexing engine 201 may store the indexed contents in a suitable location such as the database 204.

The indexing engine 201 may index the knowledge sources (including the knowledge repository 103, the sources available on the internet and so on). The indexing engine 201 may use a suitable method for indexing such as LSA (Latent Semantic Analysis), custom and so on. The indexing engine 201 may perform the indexing based on frequency of occurrence of phrases within the bug repository 102. The indexing engine 201 may also consider the proximity between various phrases for purposes of indexing. The indexing engine 201 may consider synonyms and acronyms during the process of indexing. The indexing engine 201 may distribute the indexed contents based on a plurality of factors such as the frequency of occurrence of phrases and so on. The indexing engine 201 may store the indexed contents in a suitable location such as the database 204.

Based on the indexing, the mapping engine 202 may perform mapping between the indexed contents of the bug repository 102 and the indexed contents of the knowledge sources. The mapping engine 202 further performs mapping of historical issues to the solutions for the queries. The mapping engine 202 stores the mapped results in a suitable location such as the database 204.

On detecting a user reporting a query, the autosuggestion module 203 may extract relevant portions of the text. In case the query arrives in the form of a written text (such as an email, a text based chat question and so on), the autosuggestion module 203 may extract the relevant portions of the text. In case the query arrives as a media (such as using a telephone, a voice based chat, an audiovisual chat and so on), the autosuggestion module 203 may transcribe the media into text and may extract the relevant portions of the text. Based on the extracted portions of text, the autosuggestion module 203 may match the extracted text to the mapped results. The matching may be in terms of similarity of the extracted texts to the text present in bugs previously responded, text present in the knowledge sources and so on. The threshold for matching may be defined by an authorized person such as an administrator of the engine 101. Based on the matching, the autosuggestion module 203 may provide the results of the matching to the user, through a suitable interface such as an email, a pop-up, a widget, a chat message, a recording and so on. The autosuggestion module 203 may sort the results according to a plurality of factors such as the frequency of occurrence of the extracted texts in the matched results, number of document matches and so on. The autosuggestion module 203 may enable the user to sort the results according to the preferences of the user.

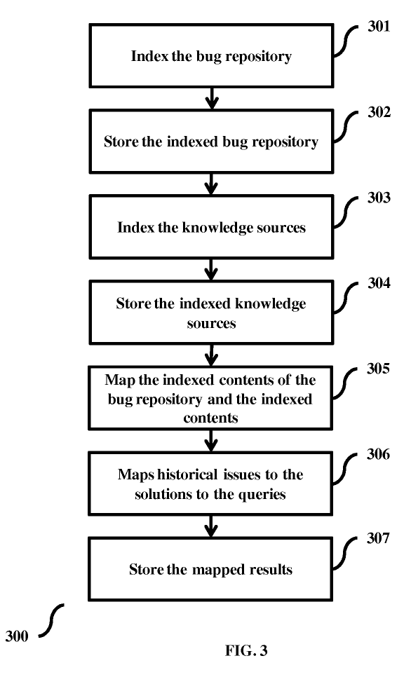

FIG. 3 is a flowchart illustrating the process of performing semantics based analysis on repositories, according to embodiments as disclosed herein. The semantic recommendation engine 101 indexes (301) the bug repository 102. The semantic recommendation engine 101 uses a suitable method for indexing such as LSA (Latent Semantic Analysis) and so on. The semantic recommendation engine 101 considers synonyms and acronyms during the process of indexing. The semantic recommendation engine 101 stores (302) the indexed contents in a suitable location. The semantic recommendation engine 101 indexes (303) the knowledge sources. The semantic recommendation engine 101 uses a suitable method for indexing such as LSA (Latent Semantic Analysis), custom and so on. The semantic recommendation engine 101 considers synonyms and acronyms during the process of indexing. The semantic recommendation engine 101 stores (304) the indexed contents in a suitable location. The semantic recommendation engine 101 further maps (305) the indexed contents of the bug repository 102 and the indexed contents of the knowledge sources. The semantic recommendation engine 101 further maps (306) historical issues to the solutions for the queries. The semantic recommendation engine 101 stores (307) the mapped results in a suitable location. The various actions in method 300 may be performed in the order presented, in a different order or simultaneously. Further, in some embodiments, some actions listed in FIG. 3 may be omitted.

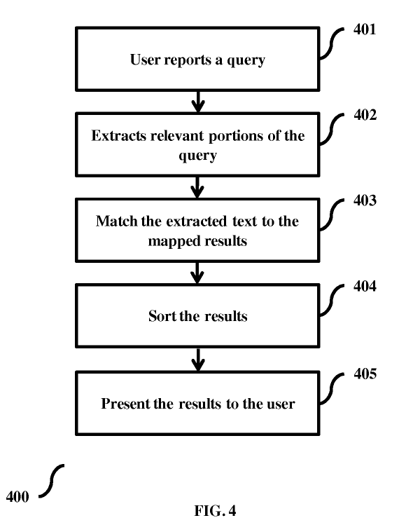

FIG. 4 is a flowchart illustrating the process of providing technical support to a client based on semantics based analysis, according to embodiments as disclosed herein. On detecting a user reporting (401) a query, the semantic recommendation engine 101 extracts (402) relevant portions of the query. The semantic recommendation engine 101 extracts the relevant portions of the text, if the query is in the form of text. The semantic recommendation engine 101 transcribes the media into text and extracts the relevant portions of the text. Based on the extracted portions of text, the semantic recommendation engine 101 matches (403) the extracted text to the mapped results. The matching may be in terms of similarity of the extracted texts to the text present in bugs previously responded, text present in the knowledge sources and so on. The semantic recommendation engine 101 sorts (404) the results according to a plurality of factors such as the frequency of occurrence of the extracted texts in the matched results, number of document matches and so on. The semantic recommendation engine 101 provides (404) the results of the matching to the user, through a suitable interface such as an email, a pop-up, a widget, a chat message, a recording and so on. The various actions in method 400 may be performed in the order presented, in a different order or simultaneously. Further, in some embodiments, some actions listed in FIG. 4 may be omitted.

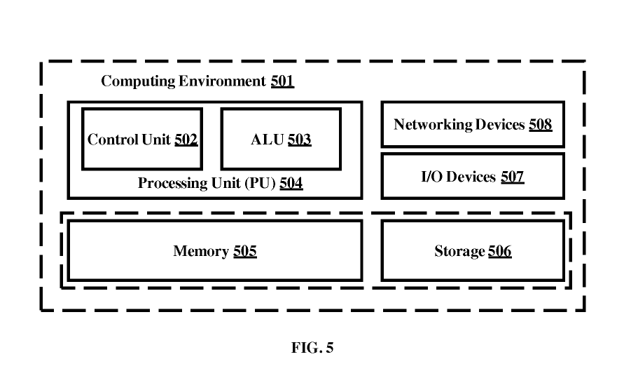

FIG. 5 illustrates a computing environment implementing the method for providing semantics based technical support based on available knowledge sources and similarity of technical support issues, according to embodiments as disclosed herein. As depicted the computing environment 501 comprises at least one processing unit 504 that is equipped with a control unit 502 and an Arithmetic Logic Unit (ALU) 503, a memory 505, a storage unit 506, plurality of networking devices 508 and a plurality Input output (I/O) devices 507. The processing unit 504 is responsible for processing the instructions of the algorithm. The processing unit 504 receives commands from the control unit in order to perform its processing. Further, any logical and arithmetic operations involved in the execution of the instructions are computed with the help of the ALU 503.

The overall computing environment 501 can be composed of multiple homogeneous and/or heterogeneous cores, multiple CPUs of different kinds, special media and other accelerators. The processing unit 504 is responsible for processing the instructions of the algorithm. Further, the plurality of processing units 504 may be located on a single chip or over multiple chips.

The algorithm comprising of instructions and codes required for the implementation are stored in either the memory unit 505 or the storage 506 or both. At the time of execution, the instructions may be fetched from the corresponding memory 505 and/or storage 506, and executed by the processing unit 504.

In case of any hardware implementations various networking devices 508 or external I/O devices 507 may be connected to the computing environment to support the implementation through the networking unit and the I/O device unit.

Embodiments disclosed herein provide users with requisite information in real time while an issue is being reported. Embodiments disclosed herein further provide users with any related solution document, if available. Embodiments disclosed herein further provide information and statistics on related/similar issues that were reported over a period of time prior to the current reporting. Embodiments disclosed herein provide automation thresholds in a dynamic manner so as to allow the specification flexibility to extract the relevant article as well as similar issues.

Embodiments disclosed herein enable a reduction in turn-around time and improve customer satisfaction by focusing on retrieving relevant issues and solutions to the reported issue.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is,

1. A method for providing semantics based technical support to a user, the method comprising of
indexing contents of a bug repository by a semantic recommendation engine;
indexing contents at least one knowledge source by the semantic recommendation engine;
mapping the indexed contents of the bug repository to the indexed contents of the at least one knowledge source by the semantic recommendation engine;
mapping historical bugs to solutions for the historical bugs by the semantic recommendation engine; and
providing a recommendation to the user by the semantic recommendation engine based on the mapping, on the semantic recommendation engine detecting the user reporting a query.

2. The method, as claimed in claim 1, wherein the semantic recommendation engine performs indexing using at least one of LSA (Latent Semantic Analysis); and custom.

3. The method, as claimed in claim 1, wherein the semantic recommendation engine considers synonyms and antonyms, during indexing.

4. The method, as claimed in claim 1, wherein the method further comprises of the semantic recommendation engine storing results of the mapping.

5. A computer program product comprising computer executable program code recorded on a computer readable non-transitory storage medium, said computer executable program code when executed, causing a method for providing semantics based technical support to a user, comprising:
indexing contents of a bug repository;
indexing contents at least one knowledge source;
mapping the indexed contents of the bug repository to the indexed contents of the at least one knowledge source;
mapping historical bugs to solutions for the historical bugs; and
providing a recommendation to the user based on the mapping, on the semantic recommendation engine detecting the user reporting a query.

6. The computer program product, as claimed in claim 5, wherein indexing is performed using at least one of LSA (Latent Semantic Analysis); and custom.

7. The computer program product, as claimed in claim 5, wherein synonyms and antonyms are considered during indexing.

8. The computer program product, as claimed in claim 5, wherein results of the mapping are stored.
